(19) United States
(12) Patent Application Publication
(10) Pub. No.: US 2002/0097678 A1
(43) Pub. Date: Jul. 25, 2002

(54) Method and apparatus for bandwidth management associated with misbehaving sessions

(76) Inventors: James A. Bisher JR., Lawrenceville, GA (US); Neil B. Buchen, Sugar Hill, GA (US)

Correspondence Address: SCIENTIFIC-ATLANTA, INC., INTELLECTUAL PROPERTY DEPARTMENT, 5030 SUGARLOAF PARKWAY, LAWRENCEVILLE, GA, 30044, US

(21) Appl. No.: 09/768,152

(22) Filed: Jan. 23, 2001

(51) Int. Cl. H04J 1/16

(52) U.S. Cl. 370/232; 370/235

(57) ABSTRACT

In a system for multiplexing a plurality of data streams, such as MPEG data streams, a data stream may exceed its maximum data rate. Each of the data streams includes a plurality of packets identified by packet identifiers that are multiplexed and the multiplexed data stream is transmitted through the system. When a data stream exceeds its maximum data rate, packets, corresponding to a predetermined packet identifier, are dropped from that data stream, thereby not transmitting the dropped packets within the multiplexed data stream.

### FIELD OF THE INVENTION

This invention relates generally to broadband communications systems, such as cable television systems and the digital headend equipment within such systems, and more specifically to a quadrature amplified modulatation (QAM) modulator.

### BACKGROUND OF THE INVENTION

Broadband systems transmit television signals to system subscribers. Broadband systems, such as cable and satellite television systems, typically include a headend for receiving programming, or sessions, from various sources and redistributing the programming to subscribers. The headend receives programming signals from a variety of sources, combines the programming signals from various sources, and transmits the combined signals to subscriber equipment. The distribution system can include a variety of media, such as coaxial cable, fiber optic cable, and satellite links. In a cable television system, the subscriber equipment, which receives the signals from the headend, can include to a cable-ready television, a cable-ready video cassette recorder (VCR), or a digital home communications terminal (DHCT) that is connected to a television, computer, or other display device.

The headend uses modulators to control the stream of data into the distribution system. In today's competitive market, the modulators must be able to accept data from equipment manufactured by many different suppliers. Increasingly, the headend is receiving and transmitting programming in a digital, for example, Moving Pictures Expert Group (MPEG), format. Transmitting programs in MPEG format is advantageous because several digitized programs can be combined and transmitted in the same 6 MHz of bandwidth that is required to transmit a single analog channel or program.

MPEG bit streams include overhead information such as MPEG tables that indicate the types and location of the programming. In a local television system, the MPEG tables include information that is specific to that local distribution system and its particular channel line-up. MPEG as referenced in this application is described in the MPEG-1 and MPEG-2 standards. The MPEG-1 standards (ISO/IEC 11172) and the MPEG-2 standards (ISO/IEC 13818) are described in detail in the International Organization for Standardization document ISO/IEC JTC1/SC29/WG11 N (June 1996 for MPEG-1 and July 1996 for MPEG-2), which is hereby incorporated by reference. Therefore, the headend system, and the modulators in particular, must add the required MPEG table data to the outgoing bit stream.

Content and data providers provide the data streams, such as video, audio, and data, to cable operators via video sources, such as video encoders and video servers. The data streams are initially prepared for transmission through the broadband system by programming, or mapping, the video, audio, and data specifications with control software within a digital network control system (DNCS), which is an element manger for processing data within the headend. The DNCS causes the data streams associated with several programs to be combined into bundled groups of sessions. More specifically, the cable operator defines and maps the specifications of the individual data streams from one or several content and data providers and, for example, multiplexes them into grouped sessions in order to maximize the use of the bandwidth available within the cable television system. For example, a typical cable television system has a forward bandwidth range from 50 mega Hertz (MHz) to 870 MHz.

In any broadband system there is a limited amount of bandwidth available and, therefore, a limited number of quadrature amplified modulation (QAM) modulator channels than can be delivered to a particular DHCT. A QAM modulator receives a digital bit stream and modulates it for transmission over the cable network. A typical QAM channel occupies 6 MHz of bandwidth and can modulate and transmit data at a rate of approximately 27 to 38 bits per second depending upon the model QAM modulator used. In a typical broadband cable environment, the bandwidth limitation determines the number of services, such as video-on-demand (VOD) and the number of channel offerings, that a cable operator may offer its customers.

For purposes of illustration, consider an example in which a QAM modulator may pass 30 MBps through one of its outputs. The operator may decide to bundle 10 session having an average bit rate of 3 megabits per second (Mbps), which includes video, audio, and data streams. Thus, an operator may map a bundled group of sessions comprising ten sessions, with five sessions requiring 3 Mbps, four sessions requiring 2.7 Mbps, and one session requiring 2.2 Mpbs, for a total of 27 Mbps allocated to a specific output of a modulator. Another criteria used when mapping sessions is a tolerance value associated with the bit rate or bandwidth that is allotted for each session. The operator decides a percentage value that each session can increase without overflowing the modulator output.

The modulator then modulates the bundled group of sessions with a particular radio frequency (RF) and the modulated signal is provided to an output of the modulator. A combiner then combines the modulated sessions with all other modulator outputs. The combined modulated output is then provided downstream via a distribution network to a plurality of DHCTs. There are numerous bundled groups of sessions that can be programmed into the DNCS and provided to numerous modulators; however, each bundled group is modulated with a different frequency across all the modulators.

A disadvantage of the prior art system is that when a session has been programmed into the DNCS and bundled into a group with other sessions, the operator may define a session incorrectly. Each session requires a certain bit rate, and it is possible that this amount will be underestimated by the operator. By way of example, if an operator programs a modulator to receive from a video server ten sessions each consuming 3 Mbps of equally partitioned bandwidth and one of the ten sessions actually requires 3.2 Mbps, an overflow results in the modulator output. The session that is not defined correctly is termed a misbehaving session. Consequently, all the sessions within that particular bundled group of sessions are affected with random video errors known as macroblocking, which affects the picture at the DHCT. Macroblocking appears as roaming blocks within the video picture seen by the subscriber. Because the misbehaving session is bundled with several other sessions within the same frequency, the overflow may result in data being dropped from any of the bundled sessions and macroblocking will randomly affect all sessions within the bundle group. Consequently, the low quality of service at the DHCT that exhibits macroblocking is unacceptable.

Thus, what is needed is a delivery system that recognizes the misbehaving sessions caused by programming errors in the DNCS and corrects or accommodates the misbehaving session to ensure a high quality of service at the DHCT.

### BRIEF DESCRIPTION OF THE DRAWINGS

FIG. 1 depicts a broadband communications system, such as a cable television system, in which the present invention may be employed.

FIG. 2 is a block diagram representation of an MPEG transport packet.

FIG. 3, consisting of FIG. 3A and FIG. 3B, illustrates the relationship between MPEG tables and an MPEG transport stream.

FIG. 4 is a block diagram representation of a modulator for modulating MPEG bit streams.

FIG. 5 is a block diagram illustrating the relationship between a multi-QAM modulator and other components in accordance with the present invention.

FIG. 6 is a flowchart of the method for creating a session performed by a modulator in accordance with the present invention.

FIG. 7 is a flowchart of the method associated with the main monitoring loop performed by a modulator in accordance with the present invention.

FIG. 8 is a flowchart of the method for overflow monitoring and recovery within the flowchart of FIG. 7 in accordance with the present invention.

FIG. 9 is a flowchart of the method for overflow prevention monitoring within the flowchart of FIG. 7 in accordance with the present invention regarding the.

FIG. 10 is a flowchart of the method for packet drop monitoring within the flowchart of FIG. 7 in accordance with the present invention.

### DETAILED DESCRIPTION OF A PREFERRED EMBODIMENT

The present invention provides a method and apparatus that detects a misbehaving session and isolates the misbehaving session to avoid macroblocking throughout all the associated bundled sessions. In an exemplary embodiment, the present invention provides a dynamic method for adaptively controlling the packets within an MPEG transport stream. This embodiment includes a processor and packet handlers, which are implemented in field programmable gate arrays. The packet handlers each remove at least one packet from the transport stream when a misbehaving session exists within the associated modulator outputs, continue to remove further packets from the transport stream when required, and determine when to stop removing packets when there no longer is an overflow.

Referring now to the drawings, in which like numerals represent like elements throughout the several figures, the present invention and an exemplary operating environment will be described.

Television System Overview

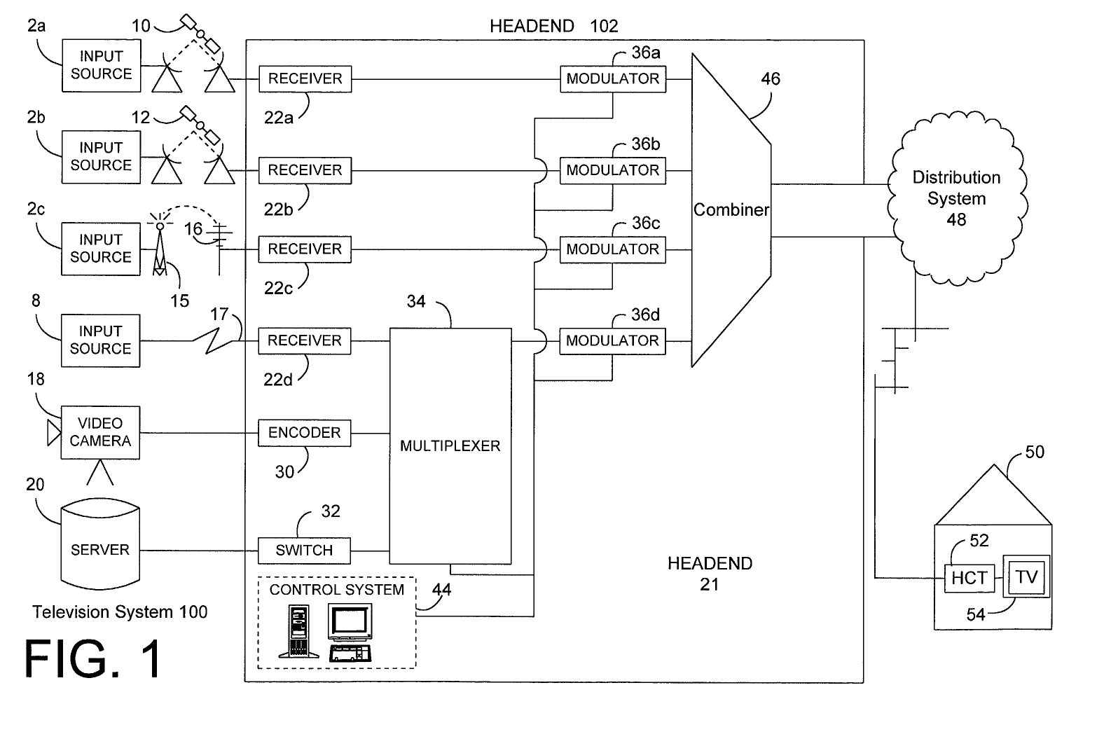

FIG. 1 illustrates various aspects of an exemplary cable television system in which the present invention is designed to operate. Those skilled in the art will understand that while digital equipment and signaling are highlighted in the following examples, analog and combinations of analog and digital of equipment and signaling can be used throughout a television system. For example a modulated output signal could be an analog signal.

The television system 100 includes a headend 21, which receives input programming from multiple input sources. The headend 21 combines the programming from the various sources and distributes the programming to subscriber locations (e.g., subscriber location 50) via distribution system 48.

In a typical system, the headend 21 receives programming from a variety of sources 2a, 2b, 2c. The programming signals may be transmitted from the source to the headend via a variety of transmission paths, including satellite 10, 12, and terrestrial broadcast 15, 16. The headend can also receive programming from a direct feed source 8 via a direct line 17. Other input sources include a video camera 18 or a server 20. The signals provided by the programming sources can include a single session or a multiplex that includes several sessions.

Programmers and television system operators both employ forms of conditional access, or encryption, to prevent piracy and ensure that those that have subscribed to and paid for their services are only receiving their signals. For example, programmers employ conditional access to ensure that those television system operators that pay for their programming only decrypt their transmissions. Similarly, television system operators can use conditional access to prevent “pirates” from receiving premium channels or pay per view programming that they have not paid for. Thus, a signal from a programmer may be decoded using “incoming” conditional access, and then encoded for transmission to the subscribers using “outgoing” conditional access. An example of a conditional access system that may be used in television system 100 is disclosed in commonly assigned, co-pending U.S. patent application Ser. No. 60/054,575 filed Aug. 1, 1997, entitled Conditional Access System, the disclosure of which is incorporated herein by reference.

The headend 21 includes a plurality of receivers 22a, 22b, 22c, 22d that are each associated with an input source. MPEG encoders such as encoder 30, are included for encoding such things as local programming or a video camera 18 feed. A switch 32 provides access to server 20, which could be a Pay-Per-View server, a data server, an Internet router, a network system, or a phone system. Some of the signals may require additional processing, such as signal multiplexing prior to being modulated. Such multiplexing is done by multiplexer 34.

The headend 21 contains a plurality of modulators, 36a, 36b, 3c, and 36d, for interfacing to the distribution system 48. The modulators convert the received programming information into a modulated output signal suitable for transmission over the distribution system 48. The output signals from the modulators are combined, using equipment such as a combiner 46, for input into the distribution system 48.

A control system 44 allows the television system operator to control and monitor the functions and performance of the television system 100. The control system 44 interfaces, monitors, and/or controls a variety of functions, including the channel lineup for the television system, billing for each subscriber, and conditional access for programming distributed to subscribers. Control system 44 provides input to the modulators for setting their operating parameters, such as system specific MPEG table packet organization or conditional access information. The control system 44 can be located at headend 21 or remotely.

The distribution system 48 distributes signals from the headend 21 to subscriber locations, such as subscriber location 50. The distribution system 48 could be an optical fiber network, a coaxial cable network, a hybrid fiber-coaxial network, a satellite system, or a direct broadcast system. There is a multitude of subscriber locations connected to distribution system 48. At subscriber location 50, a decoder 52, such as a digital home communications terminal (DHCT) decodes the signals for display on a display device, such as on a television set (TV) 54 or a computer monitor. Those skilled in the art will appreciate that the signal can be decoded in a variety of equipment, including a DHCT, a computer, a TV, a monitor, or satellite dish.

In an exemplary embodiment, the present invention is located within one or more modulators in the headend.

Moving Pictures Experts Group (MPEG) Overview

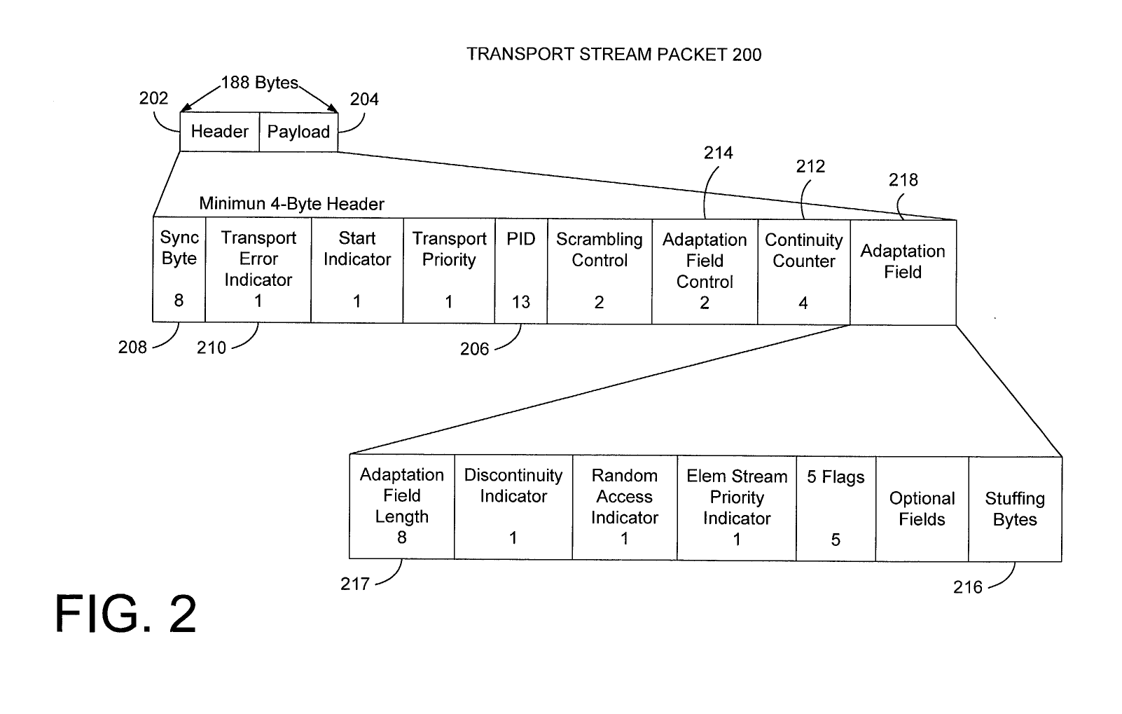

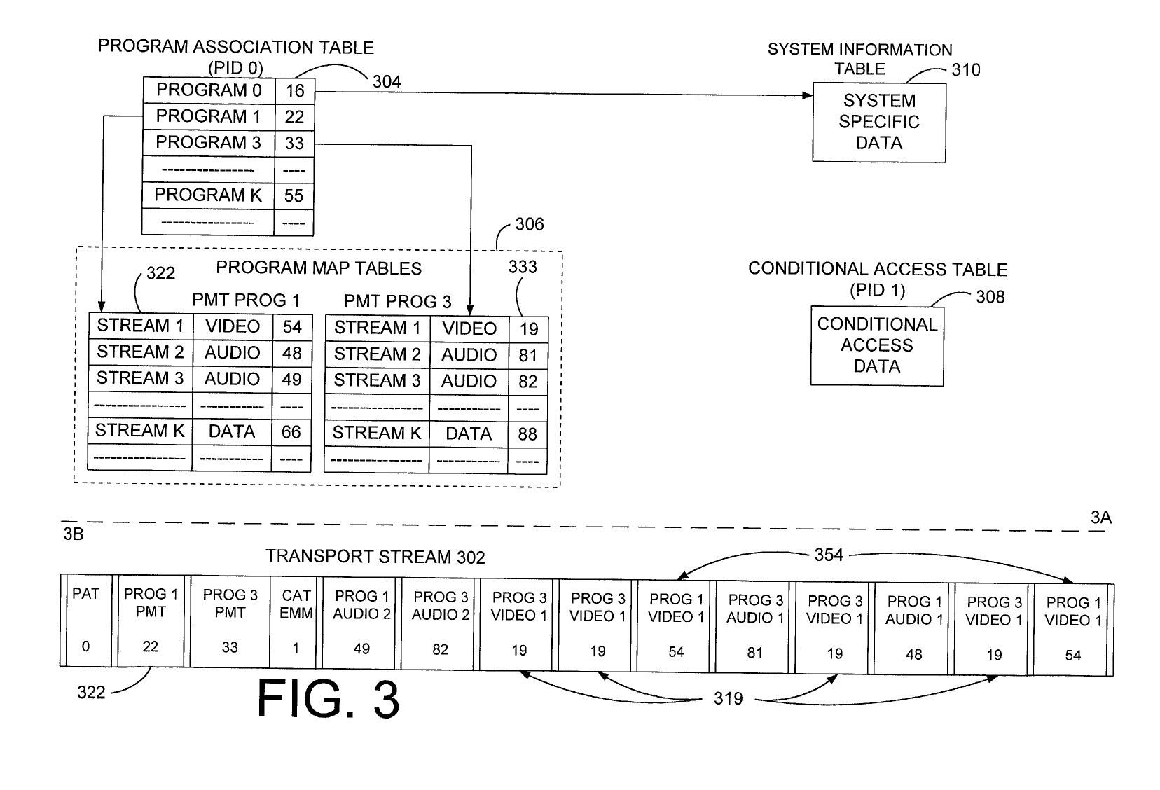

The Moving Pictures Experts Group (MPEG) was established by the International Standards Organization (ISO) for the purpose of creating standards for digital audio/video compression. The MPEG experts created the MPEG-1 and MPEG-2 standards, with the MPEG-1 standard being a subset of the MPEG-2 standard. The combined MPEG-1 and MPEG-2 standards are hereinafter referred to as MPEG. In an MPEG encoded transmission, programming and other data are transmitted in packets, which collectively make up a transport stream. An MPEG transport stream includes table packets, which provide information about the organization of the transport stream and about any conditional access scheme that is used. Additional information regarding transport stream packets, the composition of the transport stream, types of MPEG tables, and other aspects of the MPEG standards are described below. In addition, FIG. 2 and FIG. 3 provide a graphical representation of MPEG information. In an exemplary embodiment, the present invention employs MPEG table packets. However, the present invention is not so limited, and can be implemented using other types of data.

As mentioned above, an MPEG transport stream is made of packets, where each packet is identified by a packet identifier (PID). All of the packets associated with a single program, or session, will include the same PID. In general, table packets are used to indicate which PIDs are associated with each program in the transport stream. So, for example, a table packet might indicate that the transport stream includes two programs, where program 1 consists of the packets with a PID of 31, and program 2 consists of the packets with a PID of 45. Additional information regarding the makeup of an MPEG transport stream and its various components is provided below.

Packetized Elementary Stream (PES)

The output of a single MPEG audio or video encoder 30 (of FIG. 1) is an Elementary Stream, which is an endless, near-real-time signal. The Elementary Stream is broken into packets in what is referred to as a Packetized Elementary Stream (PES). These packets include header information to identify the start of the packets and must include time stamps because packetizing disrupts the time axis.

Program Stream (PS)

One video PES and a number of audio PESs can be combined to form a Program Stream (PS), provided that all of the encoders are locked to a common clock. Time stamps in each PES ensure correct correlation or lip-sync between the video and audio.

Transport Stream Packet

Transport Stream is a multiplex that includes several Program Streams, which are transported in fixed size, 188 byte, transport stream packets 200 (FIG. 2). FIG. 2 illustrates a transport stream packet 200, including a minimum 4 Byte header 202 and a payload 204. The header 202 is further expanded to illustrate the parts thereof. The numbers at the bottom of the cells, such as the 8 in Sync Byte field 208, indicate the fixed bit size of the cell. Cells with no number, such as payload 204, do not have a fixed size. In header 202, the most important information is:

Sync byte cell 208, which is recognized by a de-multiplexer or decoder so that alignment to the start of a packet can be determined.

Transport error indicator cell 210, which is set if the error correction layer above the transport layer is experiencing a raw bit error rate (BER) that is too high to be correctable. It indicates that the packet may contain errors.

Packet Identifier (PID) cell 206, which is a thirteen-bit code used by a de-multiplexer or decoder to distinguish between different types of packets.

Continuity counter cell 212, which is a four-bit value that is incremented by the encoder as each new packet having the same PID is sent. It is used to determine if any packets are lost, repeated, or out of sequence.

Header 202 also includes a start indicator cell, a transport priority cell, a scrambling control cell, an adaptation field control cell 214, and an adaptation field cell 218. Included within the adaptation field cell 218 is an adaptation field length cell 217, a discontinuity indicator cell, a random access indicator cell, an elementary stream priority indicator cell, a 5 flags cell, an optional fields cell, and a Stuffing Bytes cell 216.

In some cases more information is needed in header 202. The header can be expanded using adaptation field cell 218. If header 202 is expanded, payload 204 becomes smaller to maintain the fixed packet size of 188 bytes.

Stuffing Packets

When the required bit rate or packet size is less than the fixed bit rate or fixed packet size, the excess capacity is filled by inserting stuffing. Stuffing can be used in two ways, as stuffing bytes or as a stuffing packet. Stuffing bytes can be used with a partial payload to fill up the remainder of transport stream packet 200 to maintain the fixed packet size. Stuffing bytes can be in the payload 204 or in the Stuffing Bytes cell 216 of an expanded header 202. A stuffing packet, a transport stream packet 200 with only a header and stuffing, can be used in a fixed rate bit stream to maintain the fixed bit rate. The stuffing packet is used to fill unused or excess capacity. Stuffing packets are always identified by PID 8191, or thirteen 1's. Demultiplexers and decoders ignore packets thus identified as stuffing packets. Stuffing can be all ones (1), all zeros (0), pseudo-random 1s and 0s, or an ignore flag followed by any of the other options.

Transport Stream (TS)

Several programs and their associated PESs are multiplexed to form a single Transport Stream (TS) 302 (FIG. 3). A Transport Stream 302 differs from a Program Stream in that the PES packets are further subdivided into short fixed-size (i.e., 188 byte) transport stream packets 200 and in that multiple programs encoded with different clocks can be carried. This is possible because a transport stream 302 has a session clock reference (PCR) mechanism that allows transmission of multiple clocks.

The fixed-size transport stream packets 200 of Transport Stream 302 each contain 188 bytes. The transport stream 302 carries many different programs. In advanced applications, each program may use a different compression factor and a bit rate that can change dynamically even though the overall bit rate for Transport Stream 302 stays constant. Called statistical multiplexing, this advanced application allows a program temporally requiring a larger bandwidth to borrow bandwidth from a program that is not using all of its allocated bandwidth. In addition, each video PES could have a different number of audio and data PESs associated with it. With this flexibility in the make-up of Transport Stream 302, a decoder or demultiplexer must be able to change from one program to the next and correctly select the appropriate audio and data channels. This changing and selecting is facilitated by MPEG tables described herein below.

A Transport Stream 302 is more than just a multiplex of audio and video packets. In addition to the compressed audio, video, and data, Transport Stream 302 includes a great deal of information that describes the bit stream. This information is found in MPEG tables such as Program Specific Information tables or System Information tables, which describe the relationships of the MPEG packets and identify their corresponding packet identifier (PID). Each packet carries a PID 206 (see FIG. 2) located in the packet header 202. The MPEG tables list the PIDs for all packets associated with a particular program. The PIDs are used by the decoder or demultiplexer to change from one program to the next and correctly select the appropriate audio and data channels.

FIG. 3, including FIG. 3A and FIG. 3B, illustrates the relationship between the transport stream 302, the MPEG packets and tables therein, and the function of PIDs. Illustrative of the function of PIDs, they can be used to locate the associated tables in FIG. 3A or the corresponding packets in FIG. 3B.

FIG. 3A, the upper portion of FIG. 3, represents the different MPEG tables in the MPEG transport stream 302. For example, Program Association Table 304 indicates that all packets with a PID of 22 are Program Map Tables (PMT) associated with program 1. The PMT 322 that has a PID of 22 indicates the PIDs of the packets that make up the various components of the stream associated with program 1.

FIG. 3B, the lower portion of FIG. 3, represents the MPEG packets found in a typical MPEG transport stream 302. The MPEG packets are labeled and display their corresponding PIDs. The PIDs can identify an associated table of FIG. 3A. For example, in FIG. 3b, the packet 322, which has a PID of 22, corresponds to the PMT 322 of FIG. 3A.

Program Specific Information (PSI)

A demultiplexer or decoder can correctly select packets only if it can correctly associate them with the transport stream 302 to which they belong. A demultiplexer or decoder can do this task only if it knows what the right PIDs are. This is the function of the Program Specific Information (PSI) tables.

The PSI includes the Program Association Table (PAT) 304, the Conditional Access Table (CAT) 308, and the Program Map Table (PMT). In FIG. 3A two PMTs are shown, Program 1 PMT 322 and Program 3 PMT 333.

The PSI tables are carried in packets having unique PIDs, some of which are standardized and some of which are specified by the PAT 304 and the CAT 308. These table packets must be repeated periodically in every transport stream. The PAT 304 always has a PID of 0, the CAT 308 always has a PID of 1, and stuffing packets always have a PID of 8191. These are the only fixed PIDs in the MPEG system. The demultiplexer or decoder must determine all of the remaining PIDs by accessing the appropriate table(s).

The Program Association Table (PAT) 304 lists every program in transport stream 302. The PAT 304 identifies the PID for the packets containing the associated Program Map Tables (PMT) 306. For example, PAT 304 identifies all packets with PID 22 as being a PMT 322 associated with program 1.

PIDs of all video, audio and data elementary streams that belong in the same program stream are listed in a PMT 306 with their associated PIDs. For example, PMT 322 lists a video stream, two audio streams, a data stream, and other elementary streams belonging to program 1. PMT 322 also identifies the associated PIDs for each stream, such as PID 54 for all program 1 video streams.

In FIG. 3, the PAT 304 identifies PID 33 for all program 3 PMT 333 packets. In the corresponding PMT 333, elementary stream 1 identifies as a video stream all packets with a PID value of 19. All program 3 video 1 packets, in transport stream 302, have PID 19 as indicated by arrows 319 of FIG. 3B. PMT 322 indicates that all video packets associated with program 1 have PID 54. These packets are indicated by arrows 354 in transport stream 302 of FIG. 3B. The decoder (or a demultiplexer) can select all data for a given elementary stream by accepting only packets with the right PID, such as PID 19 for elementary stream 1 video, and rejecting the remainder. Data for an entire program can be selected using the PIDs in a PMT. For example, for the entire program 3, using PMT 333, select all video 19 PIDs, audio 81 PIDs, audio 82 PIDs, and data 88 PIDs. Packet-continuity counts ensure that every packet that is needed to decode a stream is received.

Some or all of the programs are protected or tiered so that those who have paid a subscription or fee can only view them. The transport stream 302 contains conditional access information, Conditional Access Table (CAT) 308, to administer this protection, located at PID 1 and labeled EMM in transport stream 302. The PIDs for Entitlement Management Messages (EMM) are listed in the CAT 308 packets (PID=1).

Consequently, if the decoding of a particular program is required, reference to the PAT 304 and then a PMT 306 is all that is needed to find the PIDs of all of the elementary streams in the program. If the program is encrypted, then access to the CAT 308 may also be necessary.

The first entry in the PAT 304, session 0, indicates the PID of the System Information Table 310.

System Information Table

A given System Information Table 310 contains details of more than just the transport stream 302 carrying it or the PSI of the transport stream. The System Information Table 310 may also include details of other transport streams that may be available to the same decoder, for example, by tuning to a different RF channel or steering a dish to a different satellite. The System Information Table 310 may list a number of other transport streams and each one may have a descriptor that specifies the radio frequency, orbital position, and so on. System Information Table 310 provides information describing the overall system signal(s) of a specific television system 100.

Types of a System Information Table 310 include a Digital Video Broadcast (DVB) standard Network Information Table (NIT) and an Advanced Television Systems Committee (ATSC) standard System Information (SI) table. DVB and ATSC transport streams may also contain additional service information.

Those skilled in the art will appreciate that FIGS. 1-3 are intended to provide a brief, general description of a typical television system and MPEG encoded data, and that additional information is readily available from a variety of sources.

An Exemplary System for Bandwidth Management Associated with Misbehaving Sessions

The present invention is directed to a method and a modulator that detects a misbehaving session and isolates the misbehaving session to avoid macroblocking throughout all the associated bundled group of sessions. In the present invention, session is used in the same context as a program. The present invention will be described more fully hereinafter with reference to the accompanying drawings in which like numerals represent like elements throughout the several figures, and in which an exemplary embodiment of the invention is shown. This invention may, however, be embodied in many different forms and should not be construed as limited to the embodiment set forth herein; rather, the embodiment is provided so that this disclosure will be thorough and complete, and will fully convey the scope of the invention to those skilled in the art. For example, the embodiment set forth herein refers to a multi-QAM modulator; however, a further embodiment of the present invention can be applied to a conventional QAM modulator or future developed QAM modulators.

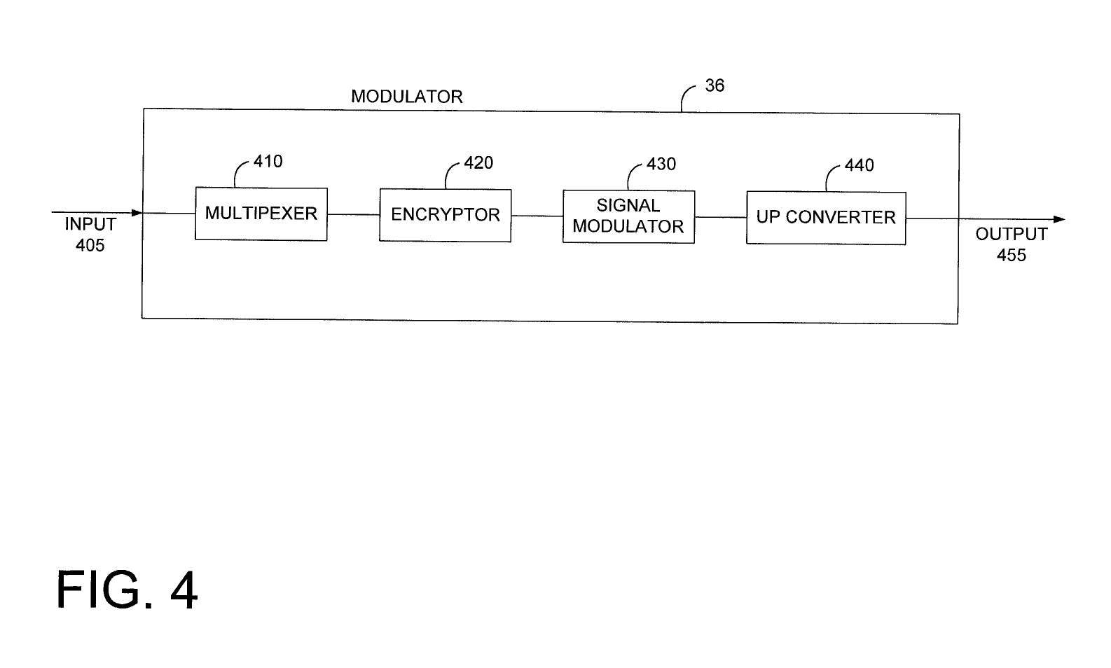

FIG. 4 is a block diagram of a modulator (such as modulator 36), which is located in headend 21 of television system 100 (FIG. 1), and which includes an embodiment of the present invention. The block diagram is a representation of a modulator for modulating MPEG transport stream 302 (FIG. 3). The modulator 36 includes a multiplexer 410 for receiving and modifying an input signal 405. Modifying the input signal 405 includes extracting incoming MPEG table information and dropping outgoing MPEG table packets, which are part of the present invention. In an exemplary embodiment the present invention is located within the modulator 36. The modulator 36 also includes an encryptor 420 for encrypting the bit stream, a signal modulator 430 for modulating the bit stream, and an up converter 440 for producing output 445.

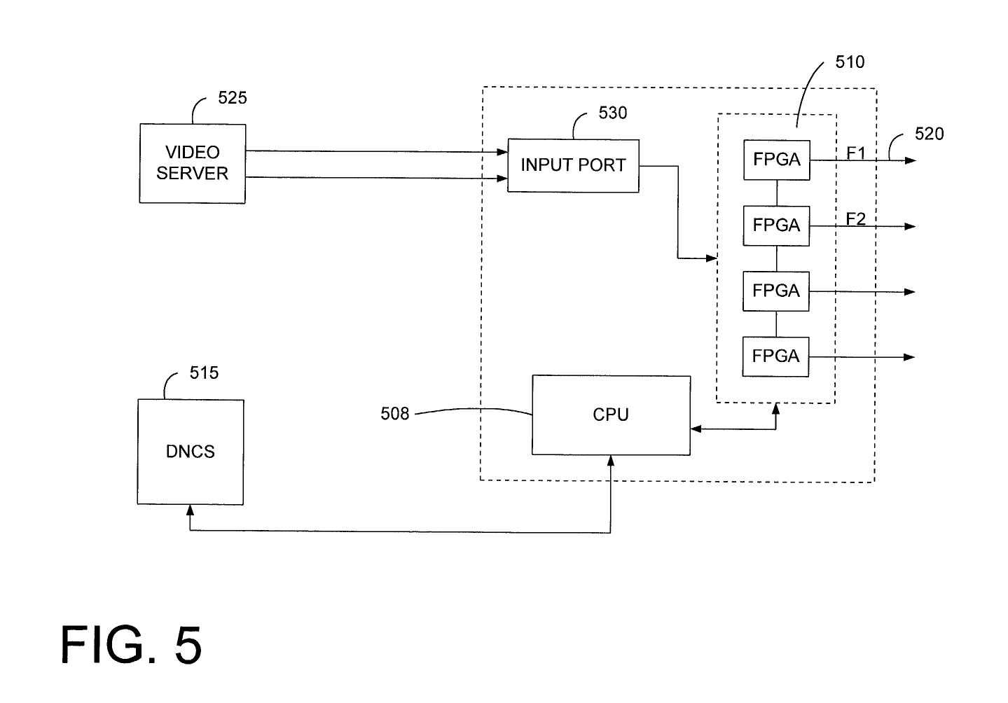

FIG. 5 illustrates a multi-QAM modulator 505 in accordance with the present invention. The modulator 505 comprises a central processing unit (CPU) 508 and field programmable gate arrays (FPGAs) 510 configured at each output of the modulator, such as output F1 520. The present invention manages the bandwidth for all content sessions provided by video sources, such as video server 525, that are mapped and programmed within the DNCS 515 and provided to the modulator 505 through an input port, such as dual input port 530. The method performed by the modulator 505, CPU 508, and FPGAs 510 includes recognizing and managing any misbehaving sessions.

Briefly described, the present invention utilizes a packet identifier (PID) priority scheme to ensure that a misbehaving session does not affect the quality of service of the other sessions that are bundled with the misbehaving session and output by the modulator 505 on a particular output frequency, such as output F1 520. The priority scheme establishes a priority table that defines each session as being either “normal” or “low priority.” All of the packets associated with normal sessions pass through the modulator, while certain packets may be dropped from low priority sessions if the bit rate of those sessions exceed a predetermined level. Initially, the priority table, which is a database that is available to the CPU 508, characterizes all sessions and their associated PIDs as normal priority, which allows the packets associated with the normal sessions to pass through the modulator 505. When a session “misbehaves” by requiring more bandwidth than the amount allotted to it, the priority scheme identifies the misbehaving session and repositions a previously selected PID (described below) associated with that session in the priority table from normal priority to low priority. The low priority session is the only session within the bundled group of sessions that may not transmit all of its associated packets downstream.

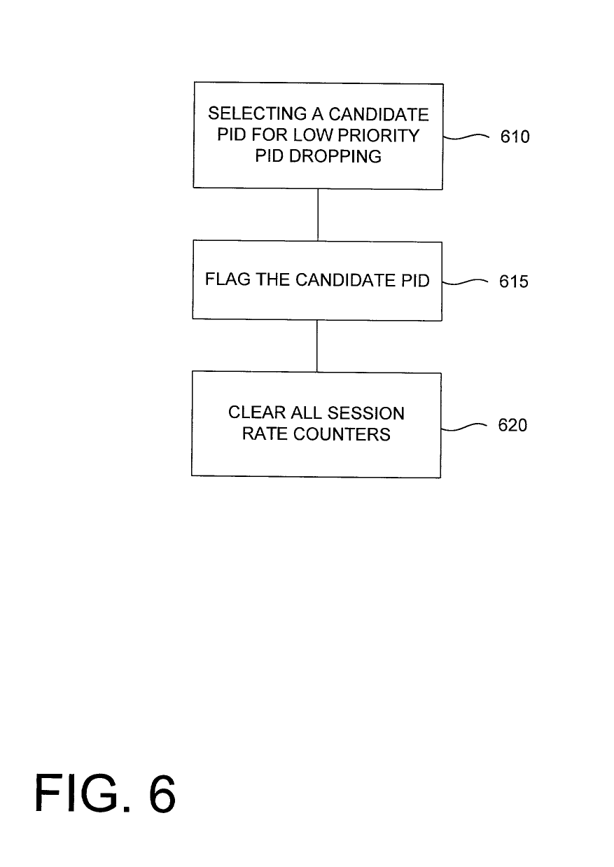

FIG. 6 is a flowchart that illustrates a method for initially creating a session and the priority table within the modulator 505 in accordance with the present invention. The flowchart shown in FIG. 6 illustrates the steps taken subsequent to the operator mapping the content in the DNCS 515. The modulator 505 receives the mapped content data in the form of a plurality of sessions. At step 610, each session is evaluated by the CPU 508 to select a candidate PID, which, in step 615, is then flagged as being the “candidate” PID that will be marked as low priority in the database if that session overflows, or misbehaves. More specifically, the candidate PID, which may be one of, for example, two video PIDs and three audio PIDs, is generally chosen to be the least noticeable PID to the viewer. Typically, a PID that corresponds to a video packet is chosen rather than an audio or a data packet because dropping a video packet tends to have the least impact on the viewer. The viewer will notice a degraded picture as opposed to corrupted audio within the misbehaving session. Additionally, each session that is created (for example, there can be ten sessions that are bundled into a group) has an associated rate counter. Once the candidate PID is selected from each of the sessions within the bundled group of sessions, all session rate counters are cleared in step 620 for tracking purposes.

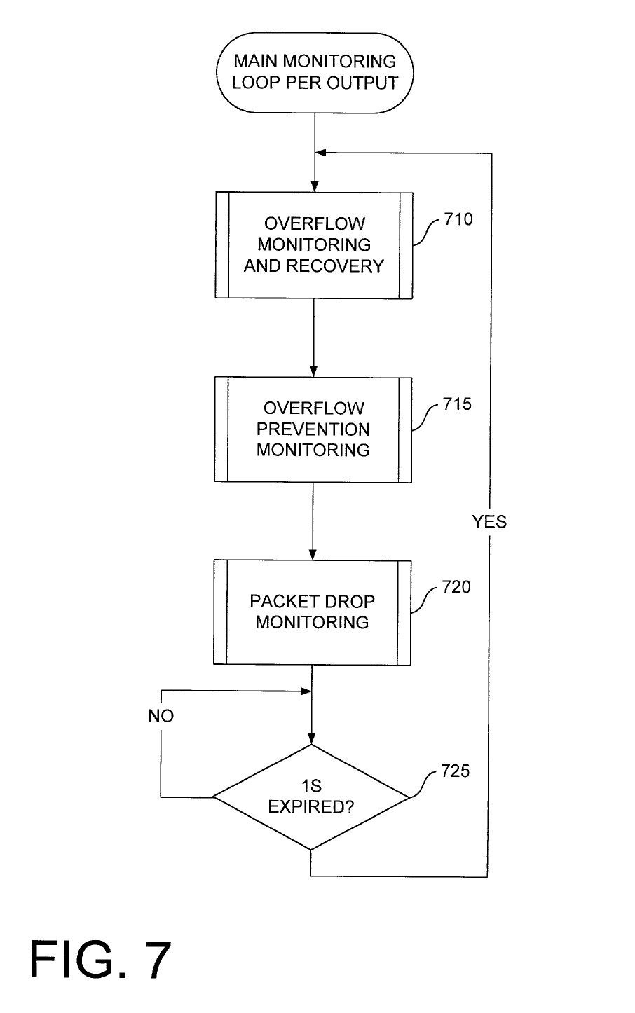

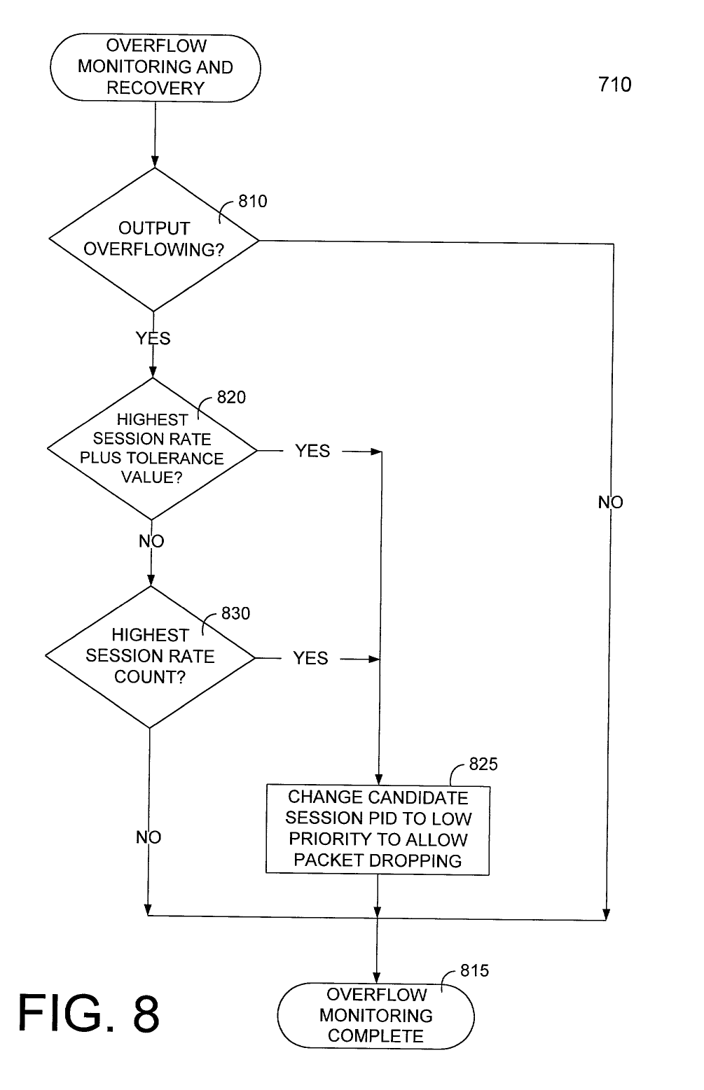

FIG. 7 is a flowchart of the steps associated with the main monitoring loop within the CPU 508 of modulator 505 in accordance with the present invention. Subsequent to creating the sessions in FIG. 6, the main monitoring loop monitors the modulator outputs, such as F1 520. FIG. 7 is an overview of the monitoring loop, and the separate steps will be discussed in further detail below in conjunction with FIGS. 8, 9, and 10. The main monitoring loop is the portion of the method steps that cycles or loops; whereas, the method steps illustrated in FIG. 6 associated with creating a session is typically run only at start up.

Briefly described, the method of FIG. 7 begins at step 710 by monitoring for overflows and recovering from any overflows. At step 715, the main monitoring loop then monitors the sessions in an attempt to prevent overflows prior to an overflow happening. Next, at step 720, the method has a dual purpose in monitoring the packets that have been dropped. The first purpose is to restart all dropped packets by changing the related PIDs from low priority back to normal priority if packets have not been dropped within a predetermined time period. The second purpose is to decide whether the optimum session has been chosen for packet dropping or if there is a better candidate that should be chosen within all the bundled group of sessions. Finally, at step 725, the main monitoring loop repeats, for example, every second.

FIG. 8 is a flowchart of an exemplary method for monitoring and recovering from overflows, which is represented by step 710 of FIG. 7. At step 810, the CPU 508 evaluates each of the outputs of the modulators, such as F1 520, to determine if an overflow is occurring. The CPU 508 provides a query and each FPGA 510 provides an indication if an overflow is occurring. If there is no overflow, the overflow monitoring and recovery is complete at step 815. If, however, an overflow is occurring in any of the outputs, the CPU 508 in step 820 provides a command to the FPGA 510 associated with the overflowing output and instructs the FPGA 510 to determine if there is a session within the bundled group of sessions that exceeds its maximum bite rate plus the tolerance that was manually entered by the operator. By way of example, a session within the bundled group of sessions may have been allotted 3 Mbps with a 5% tolerance value. If the session is actually consuming 3.3 Mbps, this session is determined to be the misbehaving session.

At step 825 the CPU 508 instructs the FPGA 510 associated with the misbehaving session to begin dropping packets identified by the previously flagged candidate PID that was chosen in step 610 (FIG. 6). The FPGA 510 accomplishes dropping packets after the flagged candidate PID is repositioned from normal priority to low priority within the priority table. The FPGA 510 then drops the packets identified by the low priority candidate PID from transport stream as needed in order to correct the overflow condition. More specifically, if the candidate PID is associated with video packet in a session that is misbehaving, the FPGA 510 begins to drop the video packets associated with the video PID as needed in order to correct the overflow condition. The FPGA 510 will continue dropping video packets from the transport stream as needed until such time as the FPGA 510 determines that the overflow is corrected.

In most cases, the overflow is corrected soon after the CPU 508 instructs the FPGA 510 to begin dropping packets within the misbehaving session. If, however, the overflow continues, the video packets will continue to be dropped. The misbehaving session continues to be transmitted downstream; however, the video picture associated with the flagged candidate video PID displays macroblocking due to the video packets being dropped from the session stream. If, however, the overflow condition continues, the FPGA will continue to drop video packets, and it is possible that all of the video picture will be dropped, thereby showing no picture.

Advantageously, all the sessions within the bundled group of sessions, with the exception of the misbehaving session, are transmitted without the effects of macroblocking in the video, as opposed to the prior art where the effects of macroblocking randomly affect all sessions within the bundled group.

If none of the sessions exhibits a bit rate that exceeds the maximum bit rate plus the tolerance value within any of the bundled sessions as defined within the DNCS 515, the FPGA 510 at step 830 evaluates and determines which session exceeds its maximum allowed bit rate without considering any tolerance values. For example, if an operator miscalculates the tolerance value associated with one session and, consequently, the session is still within the defined limits, the method then determines the misbehaving session by the maximum bit rate alone. If one exists, the candidate PID for that session is moved to the low priority category and the CPU 508 notifies the associated FPGA 510 at step 825 to begin dropping packets identified by the previously flagged candidate PID. After these steps, the overflow monitoring is complete with step 815. If all sessions are behaving correctly according to their defined limitations (i.e., within their maximum bit rate limitations), the method does not choose any candidate PID within the bundled group of sessions to begin dropping packets and macroblocking, therefore, occurs across the bundled group of sessions.

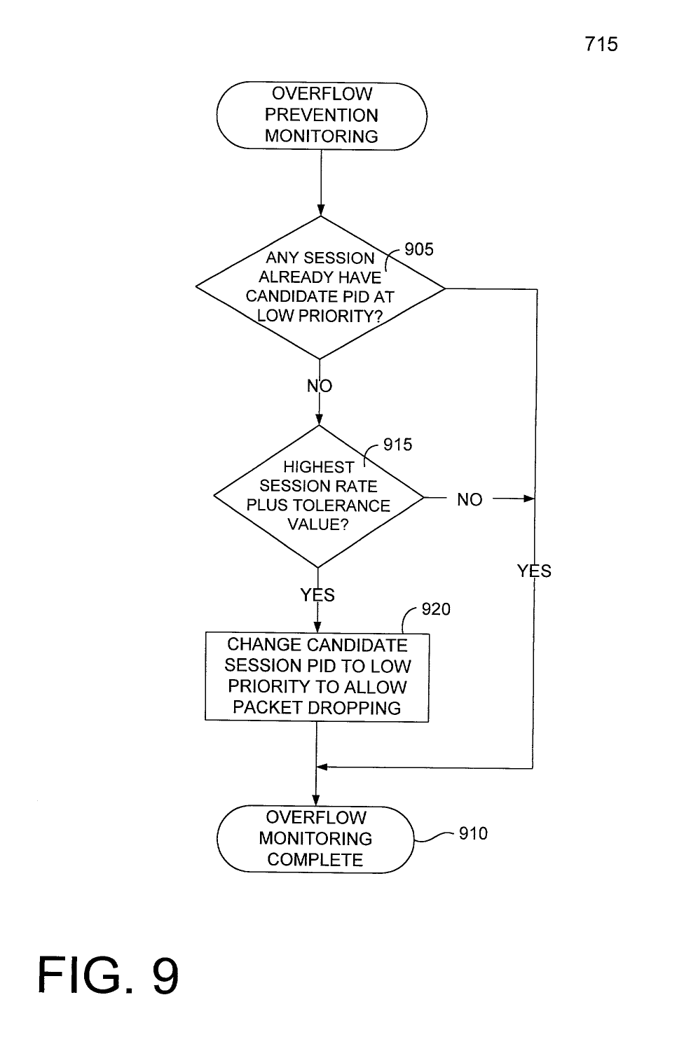

FIG. 9 is a flowchart of the steps associated with the overflow prevention monitoring step 715 of FIG. 7 in accordance with the present invention in an attempt to prevent an overflow prior to one occurring. At step 905, the CPU 508 determines if a PID associated with any session within the bundled group of sessions has already been set to low priority within the priority table. If there is a PID in the low priority category, the overflow prevention monitoring is complete at step 910. If there is not a PID in the low priority category, the CPU 508 at step 915 evaluates and determines if there is a session within the bundled group of sessions whose data rate exceeds the maximum allowed bit rate plus exceeds the tolerance value. If there is no session that exceeds its maximum allowed bit rate plus a tolerance value, then the overflow prevention monitoring is complete at step 910. If however, there is a session that exceeds its maximum allowed data rate plus a tolerance value, the CPU 508 in step 920 identifies the earlier flagged candidate PID for that session and changes it to low priority, thereby allowing the FPGA 510 to begin dropping packets that correspond to the flagged candidate PID and preventing the effects of macroblocking across all the bundled sessions before an overflow occurs.

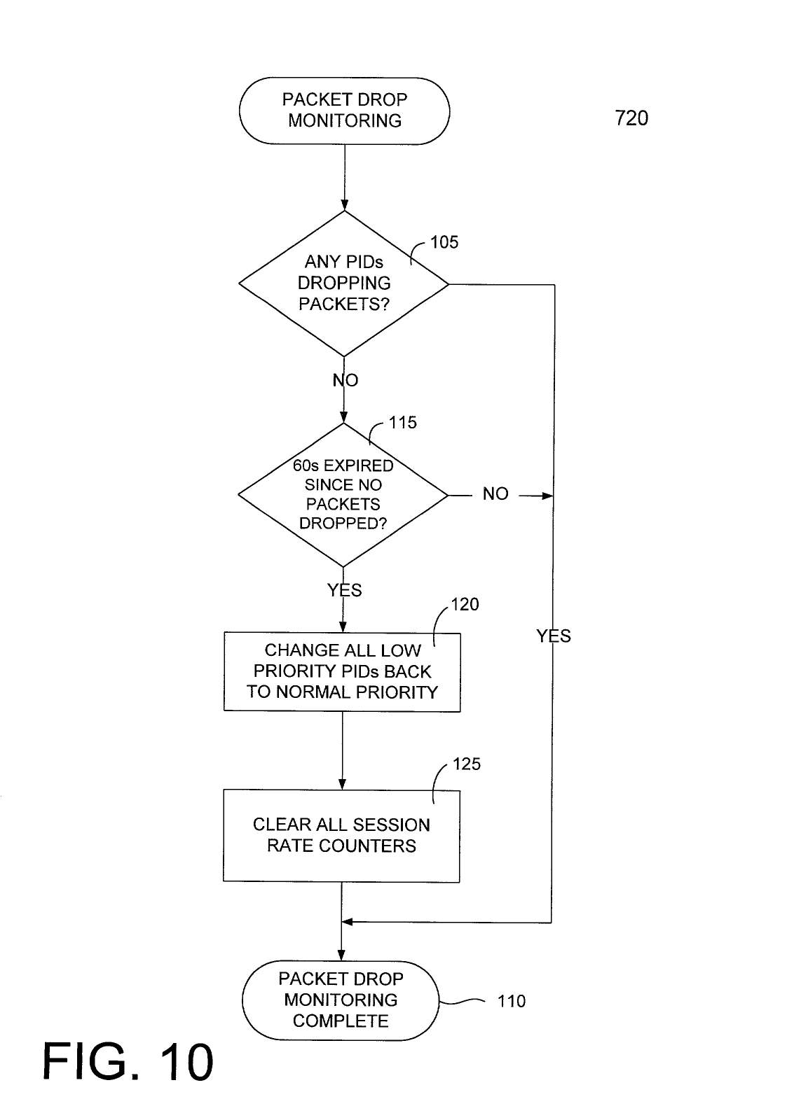

FIG. 10 is a flowchart of the steps associated with the packet drop monitoring step 720 of FIG. 7 in accordance with the present invention. The CPU 508 in step 105 queries the FPGAs 510 and determines if a packet is being dropped during this cycle of the monitoring and recovery loop. If a packet is being dropped, the packet drop monitoring is complete with step 110. If a packet is not being dropped within this cycle, step 115 determines if 60 seconds has expired since a packet has been dropped. Again, referring to FIG. 7, the main monitoring loop cycles every second. If, for example, 60 seconds has not expired, step 110 completes the packet drop monitoring and then starts the main monitoring loop again. If 60 seconds has expired, step 120 changes the low priority PID back to normal priority within the priority table. Notably, if an overflow again occurs after the flagged candidate PID has been returned to normal priority, the monitoring and recovery loop cycles the next second at step 710 (FIG. 7) and again evaluates the best candidate PID to use to begin dropping packets in case of an overflow. All session rate counters are then cleared in step 125 and the packet drop monitoring is complete.

An advantage to resetting a low priority candidate PID back to normal priority after 60 seconds in step 120 is, for example, at times a video stream may require a greater bandwidth for only a brief period of time. For example, an action video sequence requires a greater bandwidth than a calm video scene, such as the delivery of a video with the content showing a football game compared to the delivery of a video with the content of an ocean scene. Therefore, an action video may return to within the originally defined boundaries of the bandwidth. Step 120 ensures that the low priority candidate PID is still the best candidate PID within the bundled group of sessions to use to drop packets due to changing content. Every 60 seconds the candidate PID within the sessions may change to achieve the maximum protection while affecting the least number of sessions.

When an overflow occurs, an alarm is sent back to the DNCS 515 alerting the operator to the presence of a misbehaving session. At this point, the operator can determine the cause and, if the overflow resulted from underestimating the bandwidth requirement, the operator can correct the bandwidth associated with the misbehaving session.

In summary, the method within the modulator 505 monitors and recovers from potential misbehaving sessions and prevents the effects of a data overflow from affecting all sessions within the associated bundled group of sessions. The present invention greatly minimizes the effects of operator input error, while maintaining a high quality of service within the majority of a bundled group of sessions when a misbehaving session is present. It will also be appreciated that the present invention does not require great costs in manufacturing or programming.

What is claimed is:

1. In a system for multiplexing a plurality of input data streams and providing a multiplexed output data stream, each of the plurality of input data streams including a plurality of packets identified by packet identifiers, a method for dropping packets from at least one of the plurality of input data streams, comprising the steps of:
receiving input defining a maximum data rate for each of the plurality of input data streams;
determining the data rate associated with each of the plurality of input data streams;
determining whether one of the plurality of input data streams is exceeding its maximum data rate;
if one of the plurality of input data streams is exceeding its maximum data rate, dropping packets from the multiplexed output data stream, the dropped packets corresponding to a predetermined packet identifier associated with the input data stream that is exceeding its maximum data rate.

2. The method of claim 1, wherein, subsequent to determining whether one of the plurality of data streams is exceeding its maximum data rate, the steps further comprise:
reclassifying the predetermined packet identifier from normal priority to low priority within a priority table.

3. The method of claim 2, wherein a packet is dropped only as long as the one of a plurality of input data streams is exceeding its maximum data rate, and further comprising the steps of:
determining if any packets are being dropped; and
if packets are not being dropped, and if a predetermined time has passed, changing any predetermined packet identifiers in low priority back to normal priority.

4. The method of claim 1, wherein the predetermined packet identifier is determined by:
identifying a packet identifier corresponding to video packets within the plurality of packets associated with each of the plurality of input data streams.

5. The method of claim 1, further comprising the steps of:
determining when the one of the plurality of input data streams is no longer exceeding its maximum data rate; and
transmitting all packets in the multiplexed data stream.

6. The method of claim 1, further comprising the steps of:
establishing a set cycling time for repeating the method steps and again determining whether one of the plurality of input data streams is exceeding its maximum data rate.

7. The method of claim 1, wherein the plurality of input data streams are MPEG data streams.

8. In a modulator for multiplexing a plurality of input data streams and providing a modulated output data stream, each of the plurality of input data streams including a plurality of packets identified by packet identifiers, a method for dropping packets from at least one of the plurality of input data streams, comprising the steps of:
receiving input defining a maximum data rate for each of the plurality of input data streams;
determining the data rate associated with each of the plurality of input data streams;
determining whether one of the plurality of input data streams is exceeding its maximum data rate;
if one of the plurality of input data streams is exceeding its maximum data rate, dropping packets from the multiplexed output data stream, wherein the dropped packets correspond to a predetermined packet identifier associated with the data stream that is exceeding its maximum data rate;
multiplexing the plurality of input data streams and providing a multiplexed output data stream; and
modulating the multiplexed output data stream with a radio frequency (RF) signal for further transmission.

9. The method of claim 8, wherein, subsequent to determining whether one of the plurality of input data streams is exceeding its maximum data rate, the steps further comprise:
moving the predetermined packet identifier from normal priority to low priority within a priority table.

10. The method of claim 8, wherein the predetermined packet identifier is determined by:
identifying a packet identifier corresponding to video packets within the plurality of packets associated with each of the plurality of input data streams.

11. The method of claim 8, further comprising the steps of:
determining if any packets are dropping;
if packets are not dropping, and if a predetermined time has passed, changing any predetermined packet identifiers in low priority back to normal priority.

12. A broadband delivery system for receiving and transmitting information signals, the broadband delivery system comprising:
a receiver for receiving a plurality of input data streams;
at least one modulator coupled to the receiver, the modulator comprising:
an input port for receiving the plurality of input data streams, each of the plurality of input data streams having a plurality of packets identified by packet identifiers;
a multiplexer coupled to the input port for providing a multiplexed output data stream;
at least one packet handler each coupled to the multiplexer, wherein each of the at least one packet handler receives and provides the multiplexed output data stream;
a processor coupled to the multiplexer and the at least one packet handler for receiving and providing information regarding the plurality of input data streams; and
a control system coupled to the processor,
wherein the processor receives input from the control system defining a maximum data rate for each of the plurality of input data streams, and wherein each of the lat least one packet handler determines the data rate associated with each of the plurality of input data streams; and wherein the processor compares the data rate and the maximum data rate for each of the plurality of input data streams and determines whether one of the plurality of input data streams is exceeding its maximum data rate; and
wherein if one of the plurality of input data streams is exceeding its maximum data rate, drops packets from the multiplexed output data stream; wherein the dropped packets correspond to a predetermined packet identifier associated with one of the plurality of input data streams.

13. The broadband delivery system of claim 12, each of the least one packet handler further comprises:
a priority table,
wherein the predetermined packet identifier is initially at normal priority within the priority table, and wherein if one of the plurality of input data streams is exceeding its maximum data rate, the predetermined packet identifier is moved to low priority within the priority table.

14. The broadband delivery system of claim 13, wherein when the predetermined packet identifier is moved to low priority, packets associated with the predetermined packet identifier are not provided along with the multiplexed data stream.

15. The broadband delivery system of claim 12, wherein each of the at least one packet handler determines and flags a packet identifier corresponding to video packets within the plurality of packets associated with each of the plurality of input data streams, and wherein the packet identifier is the predetermined packet identifier.

16. The broadband delivery system of claim 12, wherein each of the at least one packet handler determines when the one of the plurality of input data streams is no longer exceeding its maximum data rate, wherein each of the at least one packet handler transmits all packets in the multiplexed data stream.

17. The broadband delivery system of claim 12, wherein each of the at least one packet handler is a field programmable gate array.

18. The broadband delivery system of claim 12, wherein each of the plurality of input data streams is an MPEG data stream.
